(19) United States
(12) Patent Application Publication
(10) Pub. No.: US 2023/0080489 A1
(43) Pub. Date: Mar. 16, 2023

(54) PUZZLE COMPONENT POSITION DETERMINATION SYSTEM

(71) Applicant: PARTICULA LTD., Binyamina (IL)

(72) Inventors: Udi DOR, Binyamina (IL); Amit DOR, Petah Tikva (IL)

(21) Appl. No.: 17/793,436

(22) PCT Filed: Jan. 19, 2021
(86) PCT No.: PCT/IB2021/050386

§ 371 Date: Jul. 18, 2022

Related U.S. Application Data
(60) Provisional application No. 62/963,052, filed on Jan. 19, 2020.

(51) Int. Cl. A63F 13/245; A63F 9/08; A63F 9/06; A63F 13/235; A63F 13/213; A63F 13/211; A63F 13/35; A63F 13/323

(52) U.S. Cl. CPC A63F 13/245; A63F 9/0834; A63F 9/0612; A63F 13/235; A63F 13/213; A63F 13/211; A63F 13/35; A63F 13/323; A63F 2300/1031; A63F 2300/105; A63F 2300/1062; A63F 2300/1087

(57) ABSTRACT

A three-dimensional puzzle has a monitoring puzzle piece and multiple monitored puzzle pieces. For puzzle pattern determination, the monitoring puzzle piece is equipped with sensors, a processor, a wireless transceiver, and optionally a gyroscope sensor. The monitored puzzle pieces are rotatably connected to each other and to the monitoring puzzle piece to form the puzzle. The sensors, together with the processor or alternatively with an external client, track the monitored puzzle piece rotating relative to the monitoring puzzle piece. The external client may provide feedback to a user of the puzzle. The system enables the competitions between the user and users of other puzzles without requiring the physical proximity of the competitors.

### RELATED APPLICATION

This application claims benefit under 35 U.S.C. § 119(e) of the Jan. 19, 2020 filing of U.S. Provisional Application No. 62/963,052, which is hereby incorporated by reference in its entirety.

### BACKGROUND

Puzzles of various types for people of all ages are embodied having a wide selection of shapes, sizes, and complexity. Traditionally, such puzzles were often, if not most often, enjoyed by lone users without the participation of others or even an audience of others. More recently, though, competitions have developed enabling individual users to compete with others, such as to solve a puzzle the fastest or the most efficiently.

One well-known popular non-limiting example of such a puzzle is the Rubik's Cube (originally called the “Magic Cube”), referenced hereinbelow as simply the “cube.” A basic “2×2×2” cube 20, illustrated in FIG. 1, has six faces 22, and each face 22 has a two-by-two arrangement of four face segments 24. Within a single face 22, each face segment 24 is free to move relative to the others. For any set of three faces 22 of the cube 20, for which each face 22 is adjacent to the other two faces 22, such a set of faces 22 share a common vertex 26, and the three face segments 24 adjacent the common vertex 26 are not free to move relative to each other. The cube 20 has eight cubelets 28, each cubelet 28 having three face segments 24, with the three face segments 24 each on separate adjacent faces 22.

These cubelets 28 are not really cubes themselves, although when viewing the cube 20 externally the cubelets 28 appear to be eight small cubes that together form the single big 2×2×2 cube 20. For each cubelet 28, three face segments 24 are visible externally to the cube 20, but the cubelet 28 does not have internal face segments. Instead, this particular puzzle has a post (not visible in FIG. 1) that connects the interior of the cubelet 28 to an interior mechanism (also not visible in FIG. 1), known in the art, that enables motion of cubelets 28 relative to each other:

With reference to cube 30 of FIG. 2, two face segments 32 may be repositioned to a different face 34 by rotating the two face segments 32 relative to the other two face segments 36 of their original face 38. The face segments 32, 36 may be one of six colors, for example, white, red, blue, orange, green, and yellow. One way of playing the game (puzzle) is to arrange all face segments 32, 36 of the cube 30 so that each face has face segments of only one color.

To augment the user experience, a cube may include a set of spaced-apart magnets as shown for example in FIG. 3, which illustrates the bottom half 40 of a cube to show the internal location of the magnets 42. (FIG. 3 also illustrates the cubelets' posts 44 and interior core movement mechanisms 46 discussed above, which are not visible in FIG. 1. The intricate details of the core movement mechanisms 46 are conventional and thus not shown here for clarity.)

For this puzzle, the half of the cube that is not illustrated in FIG. 3 also has magnets positioned so that, when the two halves are in place to form the full cube, the magnets of the non-illustrated sides are adjacent to and have the opposite polarity of the magnets 42 of the illustrated side, as long as the cubelets 46 form a cube shape, as in FIG. 1, and are not undergoing rotation, as shown in FIG. 2. As the user is completing a rotation of one cube half relative to the other cube half, the magnets from one cube half attract the magnets of the other cube half, thereby providing a tactile sensation indicating to the user when the rotation has finished. Although FIG. 3 illustrates only the magnet placement of the bottom cube half 40 for attraction to the magnets of the front cube half, the right and left cube halves and the front and back cube halves also have magnets arranged analogously.

For beginners, arranging all face segments so that each face has face segments of only one color is both complicated and challenging, and many players seek assistance through a variety of text and/or video guides. These guides present solution algorithms that many players can find difficult to understand. Thus, it would be useful to provide easy-to-use interactive feedback to guide a new user more easily to a solution for a 2×2×2 cube.

As discussed, more advanced players can regard these puzzles as a type of sport conducive to competition. Known competitions are sometimes referred to as “speedcubing” and “speedsolving.” Competitions and leagues are available in which the players strive to solve the puzzles as fast as possible. Participants constantly train to improve their performances, and such training needs some type of measurement of time and monitoring of face segments relative to each other. An efficient way to convey in real time pattern data of the participants in real time would be useful both competition judging and spectators observing.

Further, in the case of global pandemic circumstances restricting large gatherings of both game participants and observers, a way to efficiently communicate real time puzzle patterns would fulfill the need for continuing enjoyed pastimes in a way that does not require large physical gatherings and associated virus infection risks.

Accordingly, for three-dimensional puzzles as described, and not for merely the 2×2×2 cube, there remains an unmet need of both new and advanced players for interactive reporting, feedback, and guidance based on the relative positions of the face segments of the puzzle.

### SUMMARY

Embodiments of the present invention exploit a component position determination system to enable players to obtain interactive reporting, feedback, and guidance. The embodiments also enable competitions between players without requiring the physical proximity.

The invention may be embodied as a three-dimensional puzzle having a monitoring cubelet and seven monitored cubelets. The monitoring cubelet is equipped with sensors, a processor, and a wireless transceiver. The monitored cubelets are rotatably connected to each other and to the monitoring cubelet to collectively form six external sides of a puzzle, each side including surfaces of four mutually-adjacent cubelets. The sensors and processor together track the monitored cubelets rotating relative to the monitoring cubelet. The processor sends tracking data through the transceiver to an external client.

The invention may alternatively be embodied as a monitoring puzzle piece for forming a three-dimensional puzzle with multiple monitored puzzle pieces. The monitoring puzzle piece has sensors, a processor, and a wireless transceiver. The processor, together with the sensors, tracks the monitored puzzle pieces rotating relative to the monitoring puzzle piece, and sends tracking data through the wireless transceiver to an external client.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 shows a prior art three-dimensional puzzle having a cubicle shape with a square arrangement of four cubelets on each of six sides;

FIG. 2 shows the prior art puzzle of FIG. 1 as one puzzle face rotates relative to another puzzle face;

FIG. 3 illustrates how magnets may be added implemented in a prior art puzzle to enhance a user's experience;

FIG. 4 illustrates the invention embodied as a 2×2×2 cube with the exterior face segments of its monitoring cubelet omitted to enable viewing of the internal circuitry;

FIG. 5 illustrates the cube of FIG. 4 with the exterior face segments of its monitoring cubelet shown to enable viewing of the monitoring cubelet's charging socket;

FIG. 6 illustrates the cube of FIG. 4 interacting with an external client;

FIG. 7 illustrates various rotations possible of one half of the cube of FIG. 4 relative to the other half;

FIG. 8 illustrates how alternative rotations of one half of the cube of FIG. 4 relative to the other half may produce the same new pattern but with different cube orientations;

FIG. 9 illustrate a feature of an alternate embodiment of the invention in which the monitored cubelets have surfaces of differing light reflectivity to detect passage of the surfaces caused by cubelet rotation;

FIG. 10 illustrate a feature of another alternate embodiment of the invention in which the monitored cubelets have unique identifying surfaces to enable the identification of monitored cubelets for puzzle pattern determination;

FIG. 11 illustrates an embodiment in which the puzzle has non-planar faces;

FIG. 12 illustrates an embodiment in which the puzzle has a 2×2×1 structure

FIG. 13 illustrates an embodiment in which the puzzle has a 3×2×2 structure; and

FIG. 14 illustrates an embodiment in which the puzzle resembles a child's toy.

### DETAILED DESCRIPTION

The inventive concepts described herein can be applied to three-dimensional puzzles of varying shapes and complexities. For simplicity of description, discussed first is an embodiment of the invention applied to the traditional 2×2×2 cube structure discussed above. Reference is made to FIG. 4 accordingly.

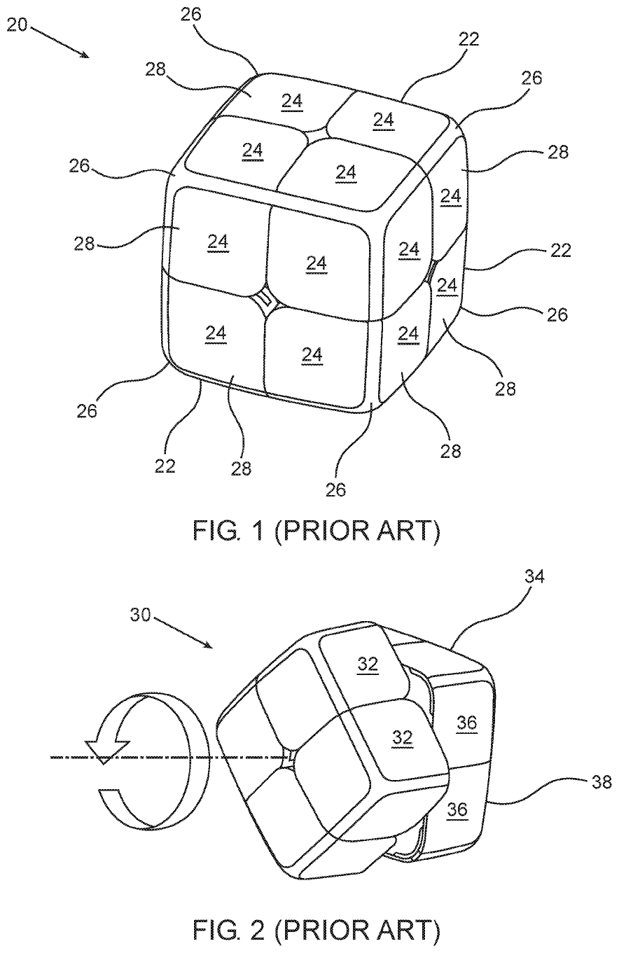

The three dimensional puzzle 48 in FIG. 4 is a cube that resembles the prior art 2×2×2 cube 20 in FIG. 1 with the exception of one puzzle piece, cubelet 50, which is illustrated without its outer faces to facilitate reference to its inner components discussed herein. The cubelet 50 is denoted now as the monitoring cubelet 50, because it is the monitoring puzzle piece of cube 48, as explained below. The other seven puzzle pieces are denoted as the monitored cubelets 52, because they are the monitored puzzle pieces of the cube 48.

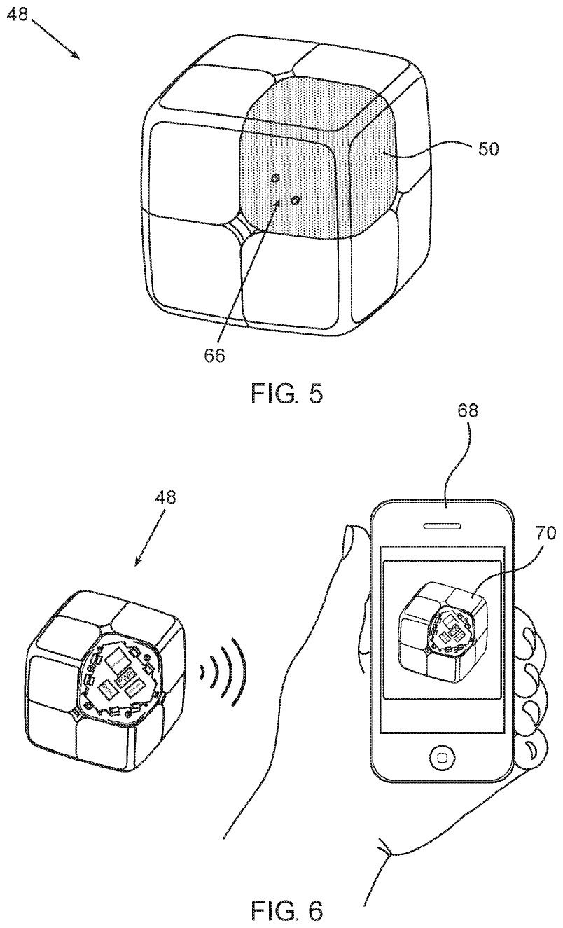

As illustrated in FIG. 4, the monitoring cubelet 50 and the seven monitored cubelets 52 are all rotatably connected to each other to collectively form the six external sides 54 of the puzzle, with each side 54 including surfaces of four mutually-adjacent cubelets 50, 52. The monitoring cubelet 50 is equipped with sensors 56, a processor 58, and a wireless transceiver 60, which may be mounted on a single printed circuit board (PCB) 62. The PCB 62 may also have mounted thereon additional components of the puzzle's circuitry, such as the power source 64, which may be a rechargeable or non-rechargeable battery. FIG. 5 shows the charging socket 66 for the power source 64. Further, the monitoring cubelet 50 may have one or more lights for special effects, such as providing illumination when a competition round begins.

The sensors 56 and processor 58 together track the monitored cubelets 52 rotating relative to the monitoring cubelet 50, and the processor 58 sends the tracking data through the transceiver 60 to an external client 68 as illustrated in FIG. 6. The tracking data may be sent using Wi-Fi or Bluetooth protocols, as non-limiting examples. The external client may be a smart phone, a tablet, or a personal computer, as non-limiting examples. In some implementations (discussed below), the external client 68 sends data through the transceiver 60 to the processor 58.

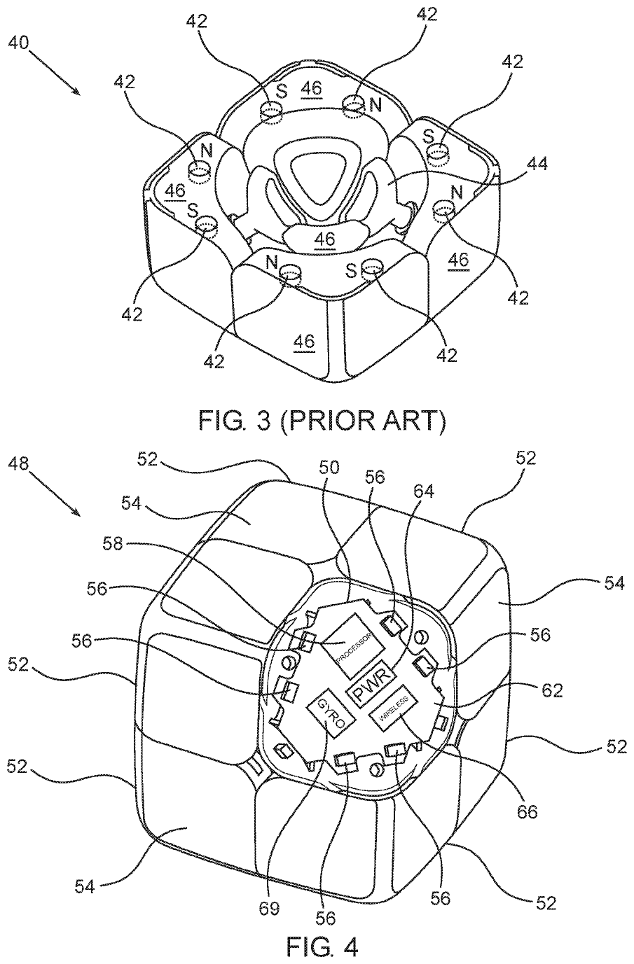

In this embodiment, the sensors 56 are quadrature encoders use magnetic sensors to sense the magnitude and direction of the monitored cubelet 52 rotations relative to the monitoring cubelet 50 as follows: Analogous to the puzzle illustrated in FIG. 3, each of the monitored cubelets 52 has a set of magnets arranged to attract magnets of adjacent monitored cubelets 52. Accordingly, the magnetic sensors used by the quadrature encoders detect the passage of the magnets caused by the monitored cubelet 62 rotations. In this embodiment, the magnetic sensors are Hall effect sensors, but other types of magnetic sensors may be used instead.

Although not required in all embodiments of the invention, the monitoring cubelet 50 in this embodiment also has a gyroscope sensor 69, which provides three-dimensional orientation (attitude) data to the processor 58. With the data from the quadrature encoders, the processor 58 or the external client, depending on how implemented, can determine the pattern of the face segments. With the three-dimensional orientation data from the gyroscope sensor 69, the processor 58 or the external client, also depending on how implemented, can determine the three-dimensional orientation of the cube 48, and such may be displayed as illustrated in FIG. 6 on the external client 68.

This embodiment determines the pattern of the face segments from knowledge of a previous pattern and tracking data indicative of the sensed rotations that cause a new pattern. The system of this embodiment can use the cube's processor or the external client to compute the new pattern based on the previous pattern and tracking data. One way of obtaining the previous pattern is for the user to enter the pattern into an application running on the external client. For cube patterns for a solid color for each face segment, a simple way for entering the pattern is for the application to display an image of the cube and the user selecting each face segment, for example, by tactile contact on a touch screen, and indicating the color of the face segment by selecting the color from a pop-up menu. Alternatively, to obtain the earlier face segment pattern the system can retrieve the pattern from storage in memory, perhaps entered into memory when the puzzle was active last. Other options for obtaining earlier pattern data include using a given pattern that results from a factory reset or obtaining data produced by photographing the puzzle. If the earlier pattern is obtained by the external client but the processor (instead of the external client) computes the pattern, the processor 58 receives the earlier pattern data from the external client 68 through the transceiver 60.

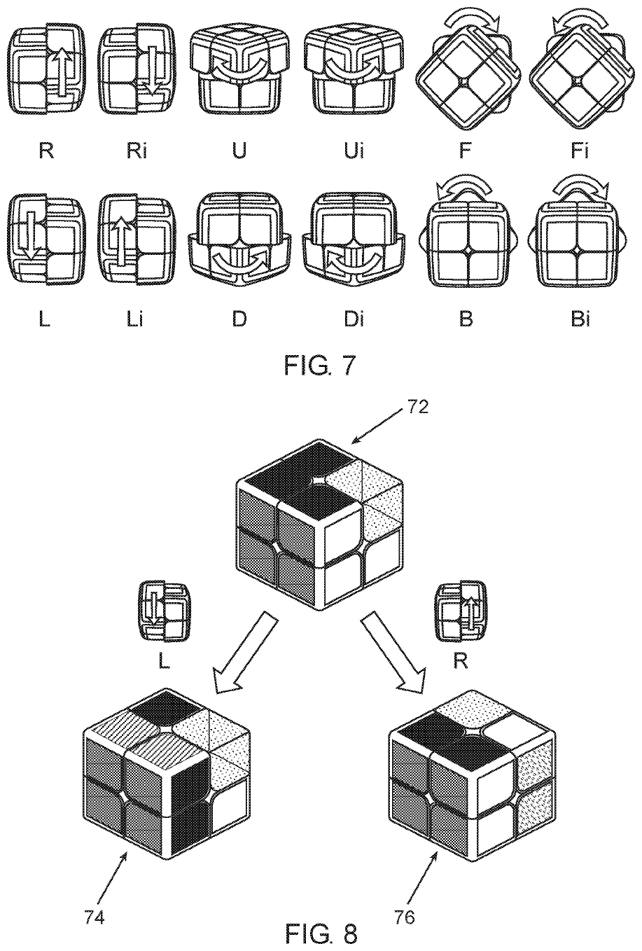

The quadrature encoders sense the magnitude and direction of cubelet rotation as discussed above. FIG. 7 illustrates the rotations that the quadrature encoders sense, the figure using the notations “R” (right), “L” (left), “U” (up), “D” (down), “F” (front), and “B” (back) to indicate which half of a cube is moving while the other half remains stationary. FIG. 7 also uses the notation “i” to indicate the inverse rotation of the rotation that does not use the notation “i”, such as “R” and “Ri”. For the rotations that do not include the notation “i”, the associated arrows indicate the direction of clockwise rotation when viewing the face of the rotating half along its axis of rotation. For the rotations that do include the notation “i”, the associated arrows indicate the direction of counter-clockwise rotation when viewing the face of the rotating half along its axis of rotation.

Although FIG. 7 illustrates twelve rotations, it is apparent from the illustrations that the rotations “R” and “L” provide the same overall new cube pattern, as is the case for the rotations “Ri” and “Li”, “U” and “D”, “Ui” and “Di”, “F” and “B”, and “Fi” and “Bi”. That is, quadrature encoder data provide sufficient data for new pattern determination, but the data alone are not sufficient to distinguish between “R” and “L” rotations, between “Ri” and “Li”, and so on. The external client 68 can display the new pattern, but, without additional information, the external client cannot indicate which half of the cube remains stationary as the pattern changes and which half the cube rotates. For some users, the changing pattern information suffices for their interests.

Nonetheless, for a user who desires that the client 68 display an image 69 of the cube 48 with the same attitude that the cube 48 itself has, the three-dimensional orientation data from the gyroscope sensor 69 are processed to determine which half of a cube 48 rotates when its pattern changes and which half remains stationary. Reference is made to FIG. 8, which illustrates an initial pattern 72 and then a subsequent left rotation 74 and an alternative right rotation 76. The pattern after the left rotation 74 and the pattern after the right rotation 76 are the same patterns, although their orientations (attitude) differ. The three-dimensional orientation data from the gyroscope sensor 69 provides the additional information to enable processing, either by the internal processor 58 or by the external client 68, to determine as follows whether the new image on the display of the external client should display an image resembling the left rotation 74 or right rotation 76.

As shown clearly in FIG. 8, the monitoring cubelet 50, remains stationary during the left rotation 74 but rotates during the right rotation 76. The gyroscope sensor 69 senses that rotation, or lack thereof, and accordingly its data with the quadrature sensor data provide sufficient information to determine the orientation of the cube 48.

It is recognized that some uses may effect a rotation by rotation both halves of the cube 48 the same amount, such as 45 degrees, in opposite directions to obtain a new pattern, instead of constraining one half to remain stationary while the other half rotates 90 degrees. Further, it is recognized that there is often, if not most often, that neither side remains entirely stationary when a cube pattern changes. In any case, the data from the gyroscope sensor 69 combines with the data from the quadrature sensor suffice to enable the display of cube image on the external client in a fashion to match the actual orientation of the cube 48.

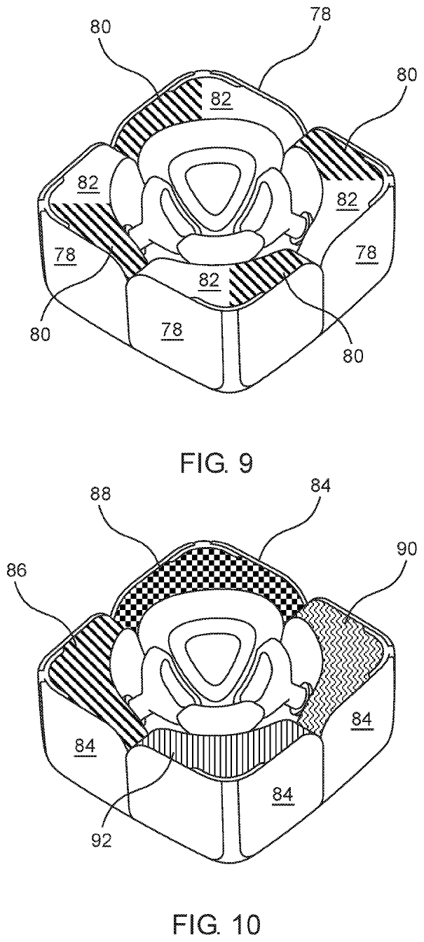

In an alternate embodiment of the invention, the monitoring cubelet does not use magnetic sensors and instead uses a combination of light sensors and light sources, which are directed toward the monitored cubelet surfaces, to detect passage of the surfaces caused by cubelet rotation. In this embodiment, as illustrated in FIG. 9, the monitored cubelets 78 have surfaces 80, 82 of differing light reflectivity, and when illuminated by the light sources the light sensors provide data to the processor to sense the magnitude and direction of the monitored cubelet 78 rotations relative to the monitoring cubelet.

To sense the direction of rotation in this embodiment, the monitoring cubelet has affixed thereto at least two light sensors so that one of the light sensors detects the transition between a more reflective surface 82 and a less reflective surface 80 at a time that the other light sensor does not such a transition. By knowing which sensor detects the transition first, the processor in the monitoring cubelet, or alternatively the external client, can detect rotation direction. The processor sends tracking data to the external client. The tracking data includes the computed rotation direction or simply the light sensor data, depending on how the processing is implemented.

In another embodiment, as a non-limiting example, instead of the monitored cubelets having surfaces designed to have differing light reflectivity, the monitored cubelets have instead metallic and non-metallic surfaces. Accordingly, the monitoring cubelet uses quadrature encoders that have capacitive sensors to detect the passage of the monitored cubelets surfaces caused by cubelet rotation.

The invention is not limited to embodiments implementing quadrature sensors to provide the magnitude and direction of rotating cubelets to determine a new puzzle pattern. Instead, the sensors in the monitoring cubelet may be such that they provide tracking data to the processor, or alternatively to an external client, to identify the monitored cubelets presently adjacent to the monitoring cubelet and from that determine the new puzzle pattern. This identification of adjacent monitored cubelets with knowledge of the puzzle pattern before the rotation suffice for determining the new puzzle pattern. The determination of the new puzzle pattern may proceed as follows:

Before the rotation, the pattern data indicate which monitored cubelets are adjacent the monitoring cubelet. After a 90 degree rotation, one of the three monitored cubelets now adjacent the monitoring cubelet will not have been adjacent the monitoring cubelet before the rotation. By identifying that “newly-arrived” monitored cubelet, with knowledge of the previous pattern data, the processor can determine which cube half rotated and in which direction. Accordingly, to identify monitored cubelets each of them has a unique signature for the sensors in the monitoring cubelet to sense/read. In alternate embodiments, an individual monitored cubelet can have three unique signatures, one for each side instead of one for all three sides, if the algorithm for determining cubelet orientation (which face point up, which face points left, . . . ) is to receive that information specifically. Nonetheless, algorithms can be implemented to determine the cubelet orientation from knowing just the previous puzzle pattern and the cubelet's identification, because only one orientation of the newly-identified monitored cubelet is possible after only one rotation.

Accordingly, in some embodiments the monitored cubelets have unique identifying surfaces, such as monitored cubelets 84 having unique identifying surfaces 86, 88, 90, and 92 as illustrated in FIG. 10. In other embodiments, the cubelet surfaces have varying colors, RFID tags, or NFC tags, as non-limiting example cubelet identifiers acting as signature, and the monitoring cubelet has corresponding signature sensors, such as RGB sensor, RFID readers, or NFC readers, sensors to identify the adjacent monitored cubelets.

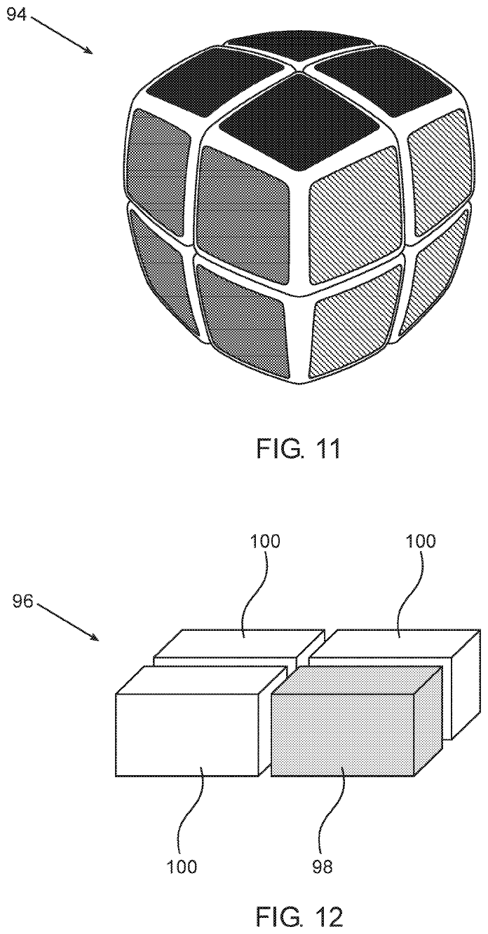

Although the puzzles of the embodiments described above are 2×2×2 cubes, principles of the invention may be applied to other shapes. For example, instead of a puzzle having planar faces, the centers of each face may protrude slightly giving a more spherical-like appearance as for puzzle 94, as illustrated in FIG. 11. Nonetheless, the overall functionality of the puzzle remains the same.

Another embodiment is puzzle 96, illustrated generally in FIG. 12, which implements a 2×2×1 structure. More specifically, a single monitoring puzzle piece 98 senses the presence of two of three monitored puzzle pieces 100 adjacent thereto. As illustrated, the puzzle pieces do not need to be cubical.

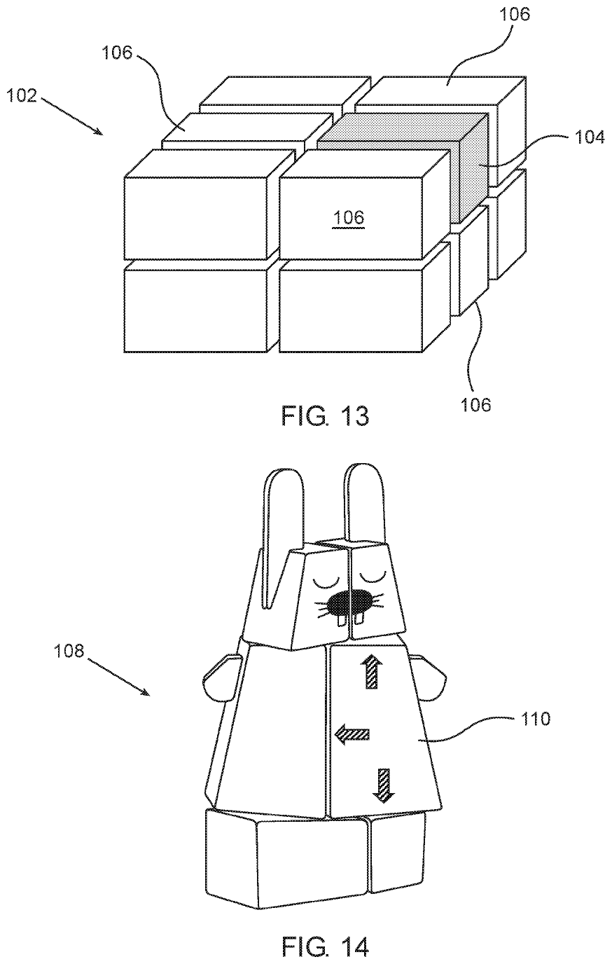

Yet another embodiment is puzzle 102, illustrated in FIG. 13, which implements a 3×2×2 structure. Here, a single monitoring puzzle piece 104 senses the presence of four of eleven monitored puzzle pieces 106 adjacent thereto.

Puzzle structure may be more artistic than those discussed above. For example, the 3×2×1 structure of puzzle 108 illustrated in FIG. 14 resembles a child's toy. The arrows in FIG. 14 indicate where the monitoring puzzle piece 110 sensors are located internally and which surfaces they observe.

As is apparent from this disclosure, embodiments of the invention enable real-time monitoring of a user engaging the puzzle. Such is useful for training users, providing real-time feedback indicating correct/incorrect maneuvers, and collecting statistics, as non-limiting examples. The external client receives data transmitted from the puzzle and provides a reliable replica of the puzzle showing both the positions of the puzzle pieces and their movements in real time. The client may process the position data and instruct users regarding the next movements to make.

Instead of or in addition to the puzzle interacting directly with a nearby client, the communication functionality of embodiments disclosed herein enables data communication through the Internet or other networks. Thus, social networking may be employed during competitions for user ranking in various categories, such as solving the puzzle in minimal time, using minimal moves, etc., forming ad hoc online competitions, and sending each user a unique set of moves so all participants start with the same patterns. Also, mobile telephone-based sensors can be used to enhance the user experience, such as by using the mobile telephone's camera to record (video) a solving session in real time during a competition. This information may be shared in various social networks and document (provide evidence) of the specific player's moves at a specific time.

The electronic capability within the monitoring puzzle piece enables more than just sensing orientation and adjacent monitored puzzle pieces. For example, a speaker and/or vibration mechanism may be added to enhance the user experience, such as by activation by signals sent from the external client. Lighting may be activated to indicate the beginning or end of a competition round.

Embodiments of the invention receive feedback based on the data of the rotational motion of the puzzle pieces. For example, the a users of a puzzle may view on the external client's display, in addition to the puzzle's updated pattern and orientation (attitude), the elapsed time since user's first move and statistics about playing the puzzle, such as speed (how many rotations in a given time), number of moves, and also instructions on how to solve the cube based on the current pattern.

In some embodiments, the external client is connected to a central server that enables a competition between a user of the puzzle and at least one user of another puzzle. Thus, users may compete without the need to travel or the need for close physical contact with others. A central server may set a unique set of moves for the players, such as a different sequence of rotations for each user, as handicaps to make them all reach the same cube pattern as a “fair match” with similar initial conditions. An alternative way to synchronize all players to the same starting pattern may be done by sharing the “chosen” initial pattern with all players, and the mobile device (i.e., mobile application) of each player shall calculate the unique set of moves required to reach the common initial state from its own unique pattern.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

We claim:

1. A three-dimensional puzzle comprising:
a monitoring cubelet equipped with sensors, a processor, and a wireless transceiver; and
seven monitored cubelets rotatably connected to each other and to the monitoring cubelet to collectively form six external sides of a puzzle, each side including surfaces of four mutually-adjacent cubelets;
wherein the sensors and processor together track the monitored cubelets rotating relative to the monitoring cubelet; and
wherein the processor sends tracking data through the transceiver to an external client.

2. The three-dimensional puzzle of claim 1, wherein the sensors are quadrature encoders that sense the magnitude and direction of the monitored cubelets' rotations relative to the monitoring cubelet.

3. The three-dimensional puzzle of claim 2, wherein:
each of the monitored cubelets has a set of magnets arranged to attract magnets of adjacent monitored cubelets; and
the quadrature encoders use magnetic sensors to detect passage of the magnets caused by cubelet rotation.

4. The three-dimensional puzzle of claim 1, wherein the sensors provide data to the processor to identify the monitored cubelets presently adjacent to the monitoring cubelet.

5. The three-dimensional puzzle of one of claims 1-4, wherein, after a rotation of a monitored cubelet relative to the monitoring cubelet, the processor determines a pattern of how the cubelets are arranged relative to each other based, at least in part, on (1) a known previous pattern of the cubelets, and on (2) the tracking data.

6. The three dimensional puzzle of one of claims 1-4, wherein the processor receives through the transceiver cubelet pattern data from an external client.

7. The three-dimensional puzzle of one of claims 1 and 4-6, wherein:
each of the monitored cubelets has surfaces of differing light reflectivity; and
the monitoring cubelet uses sensors that are light sensors and light sources directed toward the monitored cubelet surfaces to detect passage of the surfaces caused by cubelet rotation.

8. The three-dimensional puzzle of one of claims 1 and 4-6, wherein:
each of the monitored cubelets has metallic and non-metallic surfaces; and
the monitoring cubelet uses sensors that are capacitive sensors to detect passage of the monitored cubelets surfaces caused by cubelet rotation.

9. The three-dimensional puzzle of one of claims 1-8, wherein the monitoring cubelet also has a gyroscope sensor providing three-dimensional orientation data to the processor.

10. The three-dimensional puzzle of claim 9, wherein the three-dimensional orientation data from the gyroscope sensor are processed to determine which side of a puzzle rotates when a puzzle pattern changes.

11. The three-dimensional puzzle of one of claims 1-10, wherein the external client is a smart phone, a tablet, or a personal computer.

12. The three-dimensional puzzle of one of claims 1-11, wherein the external client provides feedback based on the data of the rotational motion of the cubelets.

13. The three-dimensional puzzle of one of claims 1-12, wherein the external client includes a central server that enables a competition between a user of the puzzle and at least one user of another puzzle.

14. A monitoring puzzle piece for forming a three-dimensional puzzle with multiple monitored puzzle pieces, the monitoring puzzle piece comprising:
sensors;
a processor that, together with the sensors, tracks the monitored puzzle pieces rotating relative to the monitoring puzzle piece; and
a wireless transceiver through which the processor sends tracking data to an external client.

15. The monitoring puzzle piece of claim 14, wherein the sensors are quadrature encoders that sense the magnitude and direction of the monitored puzzle piece rotations relative thereto.

16. The monitoring puzzle piece of claim 15, wherein:
each of the monitored puzzle pieces has a set of magnets arranged to attract magnets of adjacent monitored puzzle pieces; and
the quadrature encoders use magnetic sensors to detect passage of the magnets caused by puzzle piece rotation.

17. The monitoring puzzle piece of claim 14, wherein the sensors provide data to the processor to identify the monitored puzzle pieces presently adjacent thereto.

18. The monitoring puzzle piece of one of claims 14-17, wherein, after a rotation of a monitored puzzle piece relative thereto, the processor determines a pattern of how the puzzle pieces are arranged relative to each other based, at least in part, on (1) a known previous pattern of the puzzle pieces, and on (2) the tracking data.

19. The monitoring puzzle piece of one of claims 14-17, wherein the processor receives through the transceiver puzzle piece pattern data from an external client.

20. The monitoring puzzle piece of one of claims 14 and 17-19, wherein:
each of the monitored puzzle pieces has surfaces of differing light reflectivity; and
the monitoring puzzle piece uses sensors that are light sensors and light sources directed toward the monitored puzzle piece surfaces to detect passage of the surfaces caused by puzzle piece rotation.

21. The monitoring puzzle piece of one of claims 14 and 17-19, wherein:
each of the monitored puzzle pieces has metallic and non-metallic surfaces; and
the monitoring puzzle piece uses sensors that are capacitive sensors to detect passage of the monitored puzzle pieces surfaces caused by puzzle piece rotation.

22. The monitoring puzzle piece of one of claims 14-21, wherein the monitoring cubelet also has a gyroscope sensor providing three-dimensional orientation data to the processor.

23. The monitoring puzzle piece of claim 22, wherein the three-dimensional orientation data from the gyroscope sensor are processed to determine which monitored puzzle pieces rotate when a puzzle pattern changes.

24. The monitoring puzzle piece of one of claims 14-23, wherein the external client is a smart phone, a tablet, or a personal computer.

25. The monitoring puzzle piece of one of claims 14-24, wherein the external client provides feedback based on the data of the rotational motion of the puzzle pieces.

26. The monitoring puzzle piece of one of claims 14-25, wherein the external client includes a central server that enables a competition between a user of the puzzle and at least one user of another puzzle.
